(19) United States
(12) Patent Application Publication
(10) Pub. No.: US 2026/0080033 A1
(43) Pub. Date: Mar. 19, 2026

(54) METHOD AND DEVICE FOR ACQUIRING MATRIX PARAMETERS OF COHERENT ISING MACHINE, AND ELECTRONIC DEVICE

(71) Applicant: Beijing QBoson Quantum Technology Co., Ltd., Beijing (CN)

(72) Inventors: Kai Wen, Beijing (CN); Yin Ma, Beijing (CN)

(21) Appl. No.: 19/398,311

(22) Filed: Nov. 24, 2025

Related U.S. Application Data
(63) Continuation of application No. PCT/CN2024/118638, filed on Sep. 12, 2024.

(51) Int. Cl. G06F 17/16

(52) U.S. Cl. CPC G06F 17/16

(57) ABSTRACT

A method and device for acquiring matrix parameters of coherent Ising machine, and an electronic device are provided. The method includes: receiving an input matrix of the coherent Ising machine; calculating, based on the input matrix, a target parameter of the coherent Ising machine; calculating, based on the target parameter, a first matrix parameter and a second matrix parameter of the coherent Ising machine; calculating, based on the input matrix, the first matrix parameter and the second matrix parameter, a target matrix of the coherent Ising machine; and inputting the target matrix into the coherent Ising machine. The method automatically calculates two key and appropriate matrix parameters through formulas, and substitutes these parameters into preset matrix formulas to obtain the target matrix. It is no longer necessary for engineers to try different parameters and give calculation results, which greatly improves a solving success rate of the coherent Ising machine.

### TECHNICAL FIELD

The disclosure relates to the field of data processing technologies, and more particularly to a method and a device for acquiring matrix parameters of coherent Ising machine, and an electronic device.

### BACKGROUND

An input of a coherent Ising machine is a matrix J, and an output of the coherent Ising machine is

$${arg min}_{{s}_{i} ∈ \{ - 1 , + 1 \}} ( {s}^{T} J s ) ,$$

where s is a vector and and sᵢ∈{−1, +1}. In other words, a target function is set as H=Σ_{i,j}Jᵢⱼsᵢsⱼ, where sᵢ∈{−1, +1}, and Jᵢⱼ represents an element in an i^{th} row and a j^{th} column of the matrix. The coherent Ising machine can solve a value of sᵢ when H takes a minimum value. This problem is also called an Ising problem. For different matrices J, it is necessary to select appropriate matrix parameters to obtain a best effect. The existing solutions mainly obtain the best solution by manually selecting different combinations of the matrix parameters, which are manually adjusted by engineers. This method has a slow feedback speed and is prone to a phenomenon of “taking money from one pocket to pay for another”, and the success rate of the solution is low.

### SUMMARY

In order to solve at least one problem in the above background technology, the disclosure provides a method and a device for acquiring matrix parameters of a coherent Ising machine, and an electronic device.

According to the first aspect of the disclosure, a method for acquiring matrix parameters of a coherent Ising machine is provided, including:
receiving an input matrix of the coherent Ising machine;
calculating, based on the input matrix, a target parameter of the coherent Ising machine;
calculating, based on the target parameter, a first matrix parameter and a second matrix parameter of the coherent Ising machine;
calculating, based on the input matrix, the first matrix parameter and the second matrix parameter, a target matrix of the coherent Ising machine; and
inputting the target matrix into the coherent Ising machine.

In an exemplary embodiment, the inputting the target matrix into the coherent Ising machine specifically includes:
converting the target matrix into a control instruction, and sending the control instruction into a controller of the coherent Ising machine, to configure optical elements inside the coherent Ising machine, to thereby make the coherent Ising machine to execute a calculation task in response to the control instruction; where the calculation task is characterized by the input matrix.

In an embodiment, the calculating, based on the input matrix, a target parameter of the coherent Ising machine includes:
calculating, based on the input matrix, the target parameter of the coherent Ising machine by using the following formula:

$$s = \frac{n}{{\sum }_{i , j} {J}_{ij}} ;$$

where s represents the target parameter of the coherent Ising machine, n represents a dimension of the input matrix, and Jᵢⱼ represents an element in an i^{th} row and a j^{th} column of the input matrix.

In an embodiment, the calculating, based on the target parameter, a first matrix parameter and a second matrix parameter of the coherent Ising machine includes:
calculating, based on the target parameter, the first matrix parameter and the second matrix parameter of the coherent Ising machine by using the following formulas:

$$α = \frac{0.7}{s + 1} ; \\ β = \frac{0.7 s}{s + 1} ;$$

where α represents the first matrix parameter of the coherent Ising machine, β represents the second matrix parameter of the coherent Ising machine, and s represents the target parameter of the coherent Ising machine.

In an embodiment, the calculating, based on the input matrix, the first matrix parameter and the second matrix parameter, a target matrix of the coherent Ising machine includes:
calculating, based on the first matrix parameter and the second matrix parameter, the target matrix of the coherent Ising machine by using the following formula:

$$Q = α I + β J ;$$

where Q represents the target matrix of the coherent Ising machine, α represents the first matrix parameter of the coherent Ising machine, β represents the second matrix parameter of the coherent Ising machine, I represents a unit matrix, and J represents the input matrix.

According to another aspect of the disclosure, a device for acquiring matrix parameters of a coherent Ising machine is provided, including a receiving module, a first calculating module, a second calculating module, a third calculating module, and an inputting module.

The receiving module is configured to receive an input matrix of the coherent Ising machine. The first calculating module is configured to calculate a target parameter of the coherent Ising machine based on the input matrix. The second calculating module is configured to calculate a first matrix parameter and a second matrix parameter of the coherent Ising machine based on the target parameter. The third calculating module is configured to calculate a target matrix of the coherent Ising machine based on the input matrix, the first matrix parameter and the second matrix parameter. The inputting module is configured to input the target matrix into the coherent Ising machine.

In an exemplary embodiment, each of the receiving module, the first calculating module, the second calculating module, the third calculating module, and the inputting module is embodied by at least one processor and at least one memory coupled to the at least one processor, and the at least one memory stores computer programs executable by the at least one processor.

In an embodiment, the first calculating module is specifically configured to calculate, based on the input matrix, the target parameter of the coherent Ising machine by using the following formula:

$$s = \frac{n}{{\sum }_{i , j} {J}_{i j}} ;$$

where s represents the target parameter of the coherent Ising machine, n represents a dimension of the input matrix, and Jᵢⱼ represents an element in an i^{th} row and a j^{th} column of the input matrix.

In an embodiment, the second calculating module is specifically configured to calculate, based on the target parameter, the first matrix parameter and the second matrix parameter of the coherent Ising machine by using the following formulas:

$$α = \frac{0.7}{s + 1} ; \\ β = \frac{0.7 s}{s + 1} ;$$

where α represents the first matrix parameter of the coherent Ising machine, β represents the second matrix parameter of the coherent Ising machine, and s represents the target parameter of the coherent Ising machine.

In an embodiment, the third calculating module is specifically configured to calculate, based on the first matrix parameter and the second matrix parameter, the target matrix of the coherent Ising machine by using the following formula:

$$Q = α I + β J ;$$

where Q represents the target matrix of the coherent Ising machine, α represents the first matrix parameter of the coherent Ising machine, β represents the second matrix parameter of the coherent Ising machine, I represents a unit matrix, and J represents the input matrix.

In an embodiment, the inputting module specifically configured to convert the target matrix into a control instruction, and send the control instruction into a controller of the coherent Ising machine, to configure optical elements inside the coherent Ising machine, to thereby make the coherent Ising machine to execute a calculation task in response to the control instruction; where the calculation task is characterized by the input matrix.

According to still another aspect of the disclosure, a non-transitory computer-readable storage medium is provided, the non-transitory computer-readable storage medium has a computer program stored therein, and the computer program is configured to execute the method as described in any one of the above aspects.

According to yet another aspect of the disclosure, an electronic device is provided, including a processor and a memory. The memory is configured to store an executable instruction of the processor, and the processor is configured to read the executable instruction from the memory, and execute the executable instruction to implement the method as described in any one of the above aspects.

In the disclosure, after acquiring the input matrix of the coherent Ising machine, the target parameter of the coherent Ising machine is calculated based on the input matrix. Then, the first matrix parameter and the second matrix parameter of the coherent Ising machine are calculated based on the target parameter. The target matrix of the coherent Ising machine is calculated based on the input matrix, the first matrix parameter and the second matrix parameter. Finally, the target matrix is input into the coherent Ising machine. Compared with the related art, the disclosure automatically calculates two key and appropriate matrix parameters through formulas, and then substitutes these two matrix parameters into the preset matrix formula to obtain the target matrix and input it into the coherent Ising machine. It is no longer necessary for engineers to try different parameters and then give calculation results, which greatly improves the solving success rate of the coherent Ising machine.

### BRIEF DESCRIPTION OF DRAWINGS

A more complete understanding of exemplary embodiments of the disclosure may be obtained by referring to the following drawings.

FIG. 1 illustrates a flowchart of a method for acquiring matrix parameters of a coherent Ising machine according to an embodiment of the disclosure.

FIG. 2 illustrates a schematic working diagram of network communication through a personal computer and the coherent Ising machine according to an embodiment of the disclosure.

FIG. 3 illustrates a flowchart of a process for obtaining a target matrix based on an input matrix according to an embodiment of the disclosure.

FIG. 4 illustrates a flowchart of inputting the matrix into the coherent Ising machine according to an embodiment of the disclosure.

FIG. 5 illustrates a schematic structural diagram of a device for acquiring matrix parameters of the coherent Ising machine according to an embodiment of the disclosure.

FIG. 6 illustrates a schematic structural diagram of an electronic device according to an embodiment of the disclosure.

### DETAILED DESCRIPTION OF EMBODIMENTS

Below, exemplary embodiments of the disclosure will be described in detail with reference to drawings. Apparently, the described embodiments are merely some of the embodiments of the disclosure, rather than all the embodiments of the disclosure, and it should be understood that the disclosure is not limited to the exemplary embodiments described here.

It should be noted that a relative arrangement of components and steps, numerical expressions and numerical values set forth in these embodiments do not limit a scope of the disclosure unless specifically stated otherwise.

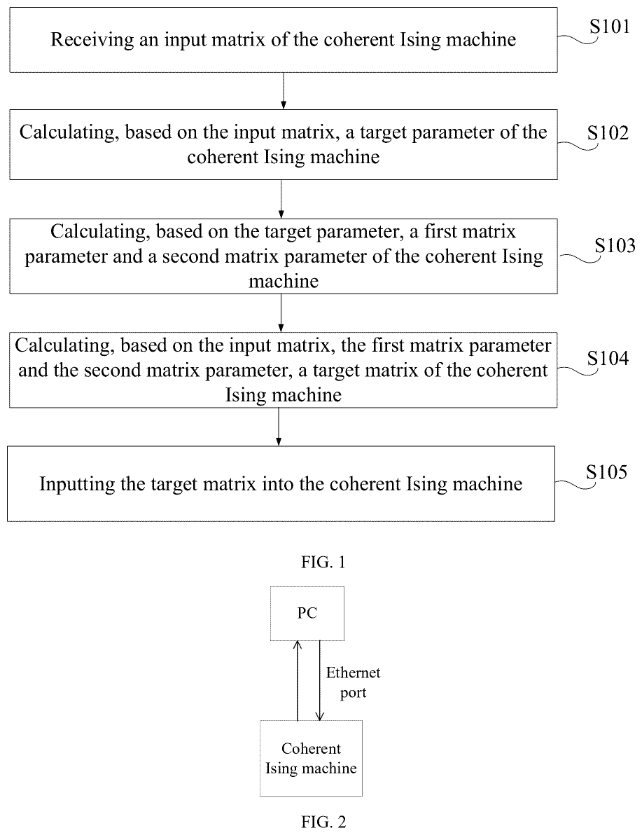

FIG. 1 illustrates a flowchart of a method for acquiring matrix parameters of a coherent Ising machine according to an embodiment of the disclosure. As shown in FIG. 1, the method for acquiring matrix parameters of a coherent Ising machine includes the following steps S101 to S105.

In step S101, an input matrix of the coherent Ising machine is received.

In the embodiments of the disclosure, a user can send the input matrix and receive returned results through a personal computer (PC) and the coherent Ising machine via network communication, as shown in FIG. 2. After the coherent Ising machine receives the input matrix sent by the user, the input matrix of the coherent Ising machine can be acquired, thereby providing data support for subsequent processing.

In step S102, a target parameter of the coherent Ising machine is calculated based on the input matrix.

In an embodiment, the target parameter of the coherent Ising machine is calculated based on the input matrix and by using the following formula:

$$s = \frac{n}{{\sum }_{i , j} {J}_{i j}} ;$$

where s represents the target parameter of the coherent Ising machine, n represents a dimension of the input matrix, and Jᵢⱼ represents an element in an i^{th} row and a j^{th} column of the input matrix.

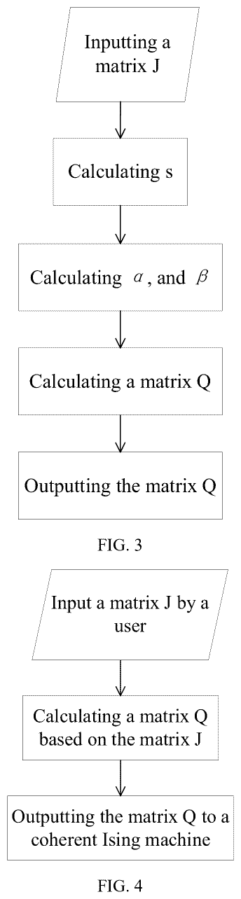

In the embodiments of the disclosure, after the coherent Ising machine receives the input matrix sent by the user, and before calculating, it needs to perform corresponding processing operations, as shown in FIG. 3. Specifically, the target parameter s of the coherent Ising machine is calculated through the formula

$$s = \frac{n}{{\sum }_{i , j} {J}_{i j}} ;$$

where n represents the dimension of the input matrix, and Jᵢⱼ represents the element in the i^{th} row and the j^{th} column of the input matrix, which provides data support for subsequent processing.

In step S103, a first matrix parameter and a second matrix parameter of the coherent Ising machine are calculated based on the target parameter.

In an embodiment, the first matrix parameter and the second matrix parameter of the coherent Ising machine are calculated based on the target parameter and by using the following formulas:

$$α = \frac{0.7}{s + 1} ;$$

$$β = \frac{0.7 s}{s + 1} ;$$

where α represents the first matrix parameter of the coherent Ising machine, β represents the second matrix parameter of the coherent Ising machine, and s represents the target parameter of the coherent Ising machine.

In the embodiments of the disclosure, as shown in FIG. 3, after calculating the target parameter s of the coherent Ising machine, the first matrix parameter α and the second matrix parameter β of the coherent Ising machine can be automatically calculated based on the target parameter s and the preset formulas

$$α = \frac{0.7}{s + 1} , and β = \frac{0.7 s}{s + 1} .$$

In step S104, a target matrix of the coherent Ising machine is calculated based on the input matrix, the first matrix parameter and the second matrix parameter.

In an embodiment, the target matrix of the coherent Ising machine is calculated based on the first matrix parameter and the second matrix parameter and using the following formula:

$$Q = α I + β J ;$$

where Q represents the target matrix of the coherent Ising machine, α represents the first matrix parameter of the coherent Ising machine, β represents the second matrix parameter of the coherent Ising machine, I represents a unit matrix, and J represents the input matrix.

In the embodiments of the disclosure, as shown in FIG. 3, after calculating the first matrix parameter α and the second matrix parameter β of the coherent Ising machine, a and B can be substituted into the matrix formula Q=αI+βJ to calculate the target matrix Q of the coherent Ising machine.

In step S105, the target matrix is input into the coherent Ising machine.

In the embodiments of the disclosure, through the above calculating processes, the matrix Q can be obtained from the matrix J, so that the matrix Q can be input to the coherent Ising machine, as shown in FIG. 4. After the coherent Ising machine calculates the result, it returns it to the user.

Therefore, in the disclosure, after acquiring the input matrix of the coherent Ising machine, the target parameter of the coherent Ising machine is calculated based on the input matrix. Then, the first matrix parameter and the second matrix parameter of the coherent Ising machine are calculated based on the target parameter. The target matrix of the coherent Ising machine is calculated based on the input matrix, the first matrix parameter and the second matrix parameter. Finally, the target matrix is input into the coherent Ising machine. Compared with the related art, the disclosure automatically calculates two key and appropriate matrix parameters through formulas, and then substitutes these two matrix parameters into the preset matrix formula to obtain the target matrix and input it into the coherent Ising machine. It is no longer necessary for engineers to try different parameters and then give calculation results, which greatly improves the solving success rate of the coherent Ising machine.

### Exemplary Device

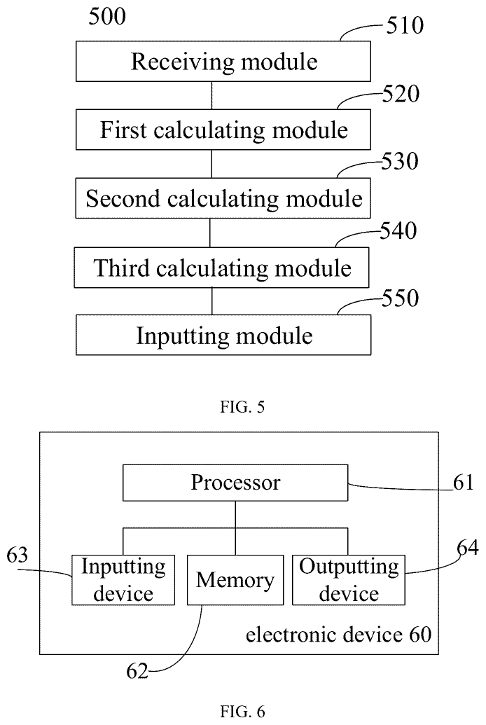

FIG. 5 illustrates a schematic structural diagram of a device for acquiring matrix parameters of the coherent Ising machine according to an embodiment of the disclosure. As shown in FIG. 5, the device 500 includes a receiving module 510, a first calculating module 520, a second calculating module 530, a third calculating module 540, and an inputting module 550.

The receiving module 510 is configured to receive an input matrix of the coherent Ising machine. The first calculating module 520 is configured to calculate a target parameter of the coherent Ising machine based on the input matrix. The second calculating module 530 is configured to calculate a first matrix parameter and a second matrix parameter of the coherent Ising machine based on the target parameter. The third calculating module 540 is configured to calculate a target matrix of the coherent Ising machine based on the input matrix, the first matrix parameter and the second matrix parameter. The inputting module 550 is configured to input the target matrix into the coherent Ising machine.

In an embodiment, the first calculating module 520 is specifically configured to calculate, based on the input matrix, the target parameter of the coherent Ising machine by using the following formula:

$$s = \frac{n}{{\sum }_{i , j} {J}_{i j}} ;$$

where s represents the target parameter of the coherent Ising machine, n represents a dimension of the input matrix, and Jᵢⱼ represents an element in an i^{th} row and a j^{th} column of the input matrix.

In an embodiment, the second calculating module 530 is specifically configured to calculate, based on the target parameter, the first matrix parameter and the second matrix parameter of the coherent Ising machine by using the following formulas:

$$α = \frac{0.7}{s + 1} ;$$

$$β = \frac{0.7 s}{s + 1} ;$$

where α represents the first matrix parameter of the coherent Ising machine, β represents the second matrix parameter of the coherent Ising machine, and s represents the target parameter of the coherent Ising machine.

In an embodiment, the third calculating module 540 is specifically configured to calculate, based on the first matrix parameter and the second matrix parameter, the target matrix of the coherent Ising machine by using the following formula:

$$Q = α I + β J ;$$

where Q represents the target matrix of the coherent Ising machine, α represents the first matrix parameter of the coherent Ising machine, β represents the second matrix parameter of the coherent Ising machine, I represents a unit matrix, and J represents the input matrix.

The device for acquiring matrix parameters of the coherent Ising machine in the embodiment of the disclosure corresponds to the method for acquiring matrix parameters of the coherent Ising machine in another embodiment of the disclosure, and will not be repeated here.

### Exemplary Electronic Device

FIG. 6 illustrates a schematic structural diagram of an electronic device according to an embodiment of the disclosure. As shown in FIG. 6, the electronic device 60 includes one or more processors 61 and a memory 62.

The processor 61 can be a central processing unit (CPU) or other form of processing unit with data processing and/or instruction execution capabilities, and can control other components in the electronic device to perform desired functions.

The memory 62 can include one or more computer program products, and the computer program products can include various forms of computer-readable storage medium, such as transitory memory and/or non-transitory memory. The transitory memory may include, for example, random access memory (RAM) and/or cache memory. The non-transitory memory may include read-only memory (ROM), hard disk, flash memory, and the like. One or more computer program instructions can be stored on the computer-readable storage medium, and the processor 61 can run the program instructions to implement the software program methods and/or other desired functions of the various embodiments of the disclosure described above. In an embodiment, the electronic device 60 may also include an input device 63 and an output device 64, which are interconnected through a bus system and/or other forms of connection mechanisms (not shown).

In addition, the input device 63 may also include, for example, a keyboard, a mouse, and so on.

The output device 64 can output various information to the outside. The output device 64 may include, for example, a display, speakers, printer, as well as a communication network and its connected remote output devices, and so on.

Certainly, for simplicity, only some of the components related to the disclosure in the electronic device 60 are shown in FIG. 6, and components such as buses and input/output interfaces are omitted. In addition, depending on the specific application, the electronic device 60 may also include any other suitable components.

### Exemplary Computer Program Product and Computer-Readable Storage Medium

In addition to the aforementioned method and device, the embodiments of the disclosure may also be a computer program product including a computer program instruction. The computer program instruction, when executed by a processor, causes the processor to perform the steps described in the “Exemplary method” section of this specification in accordance with various embodiments of the disclosure.

The computer program product can be written in any combination of one or more programming languages for executing the operations of the embodiments of the disclosure. The programming languages include object-oriented programming languages such as JAVA and C++, and conventional procedural programming languages such as “C” or similar programming languages. Program code can be executed entirely on user computing devices, partially on user devices, as a standalone software package, partially on user computing devices, partially on remote computing devices, or entirely on remote computing devices or servers.

In addition, the embodiments of the disclosure may also be a computer-readable storage medium having the computer program instruction stored therein. The computer program instruction, when executed by a processor, cause the processor to perform the steps described in the “Exemplary method” section of this specification in accordance with various embodiments of the disclosure.

The computer-readable storage medium can be any combination of one or more readable media. The readable medium can be a readable signal medium or a readable storage medium. Readable storage media can include, but are not limited to, electrical, magnetic, optical, electromagnetic, infrared, semiconductor systems, systems, or devices, or any combination thereof. More specific examples of readable storage media (non-exhaustive list) include: electrical connections with one or more wires, portable disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof.

The basic principles of the disclosure have been described above in conjunction with specific embodiments. However, it should be pointed out that the advantages, benefits and effects mentioned in the disclosure are only examples and not limitations, and cannot be considered as necessary for each embodiment of the disclosure. In addition, the specific details disclosed above are only for illustrative purposes and ease of understanding, and are not intended to be limiting. The above details do not limit the disclosure to necessarily use the specific details described above for implementation.

The various embodiments in this specification are described in a progressive manner, with each embodiment emphasizing its differences from other embodiments. The same or similar parts between the various embodiments can be referred to each other. For the system embodiment, as it basically corresponds to the method embodiment, the description is relatively simple. For relevant information, please refer to the partial explanation of the method embodiment.

The block diagrams of the device, system and equipment involved in the disclosure are only illustrative examples and are not intended to require or imply that they must be connected, arranged, or configured in the manner shown in the block diagrams. As those skilled in the art will recognize, these device, system, and equipment can be connected, arranged, and configured in any way. Terms such as “including”, “comprising”, and “having” are open-ended vocabulary that refer to “including but not limited to” and can be used interchangeably with it. The terms “or” and “and” used here refer to the word “and/or” and can be used interchangeably, unless the context clearly indicates otherwise. The term “such as” used here refers to the phrase “such as but not limited to” and can be used interchangeably with it.

There may be many ways to implement the method and system of the disclosure. For example, the method and system of the disclosure can be implemented through software, hardware, firmware, or any combination of software, hardware, and firmware. The above order of steps used for the method is for illustration purposes only, and the steps of the method of the disclosure are not limited to the specific order described above, unless otherwise specifically stated. In addition, in some embodiments, the disclosure may also be implemented as programs recorded in a recording medium, including machine-readable instructions for implementing the method according to the disclosure. Therefore, the disclosure also covers a recording medium storing a program for executing the method according to the disclosure.

It should also be pointed out that in the system, device, and method of the disclosure, each component or step can be decomposed and/or recombined. These decompositions and/or re-combinations should be considered as equivalent solutions of the disclosure. Provide the above description of the disclosed aspects to enable those skilled in the art to make or use the disclosure. Various modifications to these aspects are obvious to those skilled in the art, and the general principles defined herein can be applied to other aspects without departing from the scope of the disclosure. Therefore, the disclosure is not intended to be limited to the aspects shown herein, but to the widest scope consistent with the principles and novel features disclosed herein.

The above description has been provided for the purpose of illustration and description. Furthermore, this description is not intended to limit the embodiments of the disclosure to the form disclosed herein. Although multiple example aspects and embodiments have been discussed above, those skilled in the art will recognize certain variations, modifications, alterations, additions, and sub combinations thereof.

What is claimed is:

1. A method for acquiring matrix parameters of a coherent Ising machine, comprising:
receiving an input matrix of the coherent Ising machine;
calculating, based on the input matrix, a target parameter of the coherent Ising machine;
calculating, based on the target parameter, a first matrix parameter and a second matrix parameter of the coherent Ising machine;
calculating, based on the input matrix, the first matrix parameter and the second matrix parameter, a target matrix of the coherent Ising machine; and
inputting the target matrix into the coherent Ising machine.

2. The method as claimed in claim 1, wherein the calculating, based on the input matrix, a target parameter of the coherent Ising machine comprises:
calculating, based on the input matrix, the target parameter of the coherent Ising machine by using the following formula:
$$s = \frac{n}{{\sum }_{i , j} {J}_{i j}} ;$$
wherein s represents the target parameter of the coherent Ising machine, n represents a dimension of the input matrix, and Jᵢⱼ represents an element in an i^{th} row and a j^{th} column of the input matrix.

3. The method as claimed in claim 1, wherein the calculating, based on the target parameter, a first matrix parameter and a second matrix parameter of the coherent Ising machine comprises:
calculating, based on the target parameter, the first matrix parameter and the second matrix parameter of the coherent Ising machine by using the following formulas:
$$α = \frac{0.7}{s + 1} ;$$
$$β = \frac{0.7 s}{s + 1} ;$$
wherein α represents the first matrix parameter of the coherent Ising machine, β represents the second matrix parameter of the coherent Ising machine, and s represents the target parameter of the coherent Ising machine.

4. The method as claimed in claim 1, wherein the calculating, based on the input matrix, the first matrix parameter and the second matrix parameter, a target matrix of the coherent Ising machine comprises:
calculating, based on the first matrix parameter and the second matrix parameter, the target matrix of the coherent Ising machine by using the following formula:
$$Q = α I + β J ;$$
wherein Q represents the target matrix of the coherent Ising machine, α represents the first matrix parameter of the coherent Ising machine, β represents the second matrix parameter of the coherent Ising machine, I represents a unit matrix, and J represents the input matrix.

5. A device for acquiring matrix parameters of a coherent Ising machine, comprising:
a receiving module, configured to receive an input matrix of the coherent Ising machine;
a first calculating module, configured to calculate a target parameter of the coherent Ising machine based on the input matrix;
a second calculating module, configured to calculate a first matrix parameter and a second matrix parameter of the coherent Ising machine based on the target parameter;
a third calculating module, configured to calculate a target matrix of the coherent Ising machine based on the input matrix, the first matrix parameter and the second matrix parameter; and
an inputting module, configured to input the target matrix into the coherent Ising machine.

6. The device as claimed in claim 5, wherein the first calculating module is specifically configured to calculate, based on the input matrix, the target parameter of the coherent Ising machine by using the following formula:
$$s = \frac{n}{{\sum }_{i , j} {J}_{i j}} ;$$
wherein s represents the target parameter of the coherent Ising machine, n represents a dimension of the input matrix, and Jᵢⱼ represents an element in an i^{th} row and a j^{th} column of the input matrix.

7. The device as claimed in claim 5, wherein the second calculating module is specifically configured to calculate, based on the target parameter, the first matrix parameter and the second matrix parameter of the coherent Ising machine by using the following formulas:
$$α = \frac{0.7}{s + 1} ;$$
$$β = \frac{0.7 s}{s + 1} ;$$
wherein α represents the first matrix parameter of the coherent Ising machine, β represents the second matrix parameter of the coherent Ising machine, and s represents the target parameter of the coherent Ising machine.

8. The device as claimed in claim 5, wherein the third calculating module is specifically configured to calculate, based on the first matrix parameter and the second matrix parameter, the target matrix of the coherent Ising machine by using the following formula:
$$Q = α I + β J ;$$
wherein Q represents the target matrix of the coherent Ising machine, α represents the first matrix parameter of the coherent Ising machine, B represents the second matrix parameter of the coherent Ising machine, I represents a unit matrix, and J represents the input matrix.

9. A non-transitory computer-readable storage medium having a computer program stored therein, wherein the computer program is configured to execute the method as claimed in claim 1.

10. An electronic device, comprising:
a processor; and
a memory, configured to store an executable instruction of the processor; and
wherein the processor is configured to read the executable instruction from the memory, and execute the executable instruction to implement the method as claimed in claim 1.
